(19) United States
(12) Patent Application Publication
(10) Pub. No.: US 2025/0281866 A1
(43) Pub. Date: Sep. 11, 2025

(54) HONEYCOMB STRUCTURE

(71) Applicant: NGK INSULATORS, LTD., Nagoya-City (JP)

(72) Inventors: Fumihiko YOSHIOKA, Novi, MI (US); Yuki FUKUMI, Kasugai-Shi (JP); Kyohei KATO, Novi, MI (US); Katsunori TANAKA, Nagoya-Shi (JP); Yudai KURIMOTO, Shanghai (CN)

(73) Assignee: NGK INSULATORS, LTD., Nagoya-City (JP)

(21) Appl. No.: 19/058,096

(22) Filed: Feb. 20, 2025

(30) Foreign Application Priority Data
Mar. 5, 2024 (JP) 2024-033214

(51) Int. Cl. B01D 46/24; B01D 53/86; B01J 35/57

(52) U.S. Cl. CPC B01D 46/2474; B01D 46/2429; B01D 46/24491; B01D 46/24492; B01D 46/247; B01D 46/2482; B01D 46/2484; B01D 46/2492; B01D 46/2494; B01D 53/86; B01J 35/57; B01D 2255/9155; B01D 2255/9202; B01D 2255/9205

(57) ABSTRACT

A pillar-shaped honeycomb structure includes inlet cells and outlet cells adjacent to at least one of the inlet cells with a partition wall interposed therebetween, wherein a ratio of an opening area (Cᵢₙ) of each of the inlet cells to an opening area (Cₒᵤₜ) of each of the outlet cells, a thickness (WT) of the partition wall, a cell density (CD) based on a total number of the inlet cells and the outlet cells, a depth (PD) of a sealing portion, and a distance (OF) between the midpoint of a line segment connecting the centers of gravity of the inlet cells and the outlet cells adjacent to each other with the partition wall interposed therebetween and the center of the partition wall intersected by the line segment, satisfy predetermined conditions, and furthermore, the honeycomb structure satisfies 2≤OF×CD/(WT×PD)≤7.

### CROSS REFERENCE TO RELATED APPLICATIONS

The present invention claims the benefit of priority to Japanese Patent Application No. 2024-33214 filed on Mar. 5, 2024 with the Japanese Patent Office, the entire contents of which are incorporated herein by reference in its entirety.

### FIELD OF THE INVENTION

The present invention relates to a honeycomb structure.

### BACKGROUND OF THE INVENTION

Exhaust gas emitted from internal combustion engines such as diesel engines contains large amounts of particulate matter (PM), including soot, which is primarily composed of carbon causing an environmental pollution, and ash, which is generated as the remains of combustion of calcium (Ca). Since particulate matter is known to be carcinogenic, it is essential to prevent its release into the atmosphere. Currently, in addition to the conventional weight-based quantity restrictions, strict PM count restrictions on the number of PM particles are now being imposed, mainly in Europe. For this reason, exhaust systems of diesel engines and the like are generally equipped with a filter (Diesel Particulate Filter: DPF) to collect particulates. In recent years, particulate matter emitted from gasoline engines has also become a problem, and gasoline engines are now being equipped with a filter (Gasoline Particulate Filter: GPF).

As a filter, a wall-flow type filter designed to allow exhaust gas to pass through porous partition walls is effective. Specifically, a wall-flow filter has a number of inlet cells and a number of outlet cells which are adjacent to each other with porous partition walls interposed therebetween, and can be configured with a honeycomb structure that captures PM while exhaust gas passes through the partition walls. A catalyst according to a target can also be carried on the surface of the partition walls.

A wall-flow type filter made of a honeycomb structure is required to have various properties such as excellent PM collection performance, low pressure loss, excellent catalytic performance when carrying a catalyst, resistance to ash clogging, and excellent mechanical strength.

Japanese Patent Application Publication No. 2023-147536 (Patent Literature 1) discloses that by controlling the cross-sectional shape of the inflow cells, the ratio of the cross-sectional area of the outflow cells to the cross-sectional area of the inflow cells, the thickness of the partition walls, the cell density, the shape of the sealing portions, the porosity of the partition walls, and the like within predetermined ranges, it is possible to obtain a honeycomb filter that enables low pressure loss, excellent erosion resistance of the sealing portions, as well as excellent thermal shock resistance.

Japanese Patent No. 7353217 (Patent Literature 2) discloses that a honeycomb filter that has excellent collection performance and is capable of reducing pressure loss can be obtained by controlling the porosity, average pore size, pore size distribution, and thickness of the partition walls within predetermined ranges.

### PRIOR ART

### Patent Literature

[Patent Literature 1] Japanese Patent Application Publication No. 2023-147536
[Patent Literature 2] Japanese Patent No. 7353217

### SUMMARY OF THE INVENTION

However, conventional honeycomb structures have not been able to satisfy all of the requirements: excellent PM collection performance, low pressure loss, excellent catalytic performance when carrying catalyst, difficulty to be clogged by ash, and excellent mechanical strength. Although Patent Literature 1 describes a honeycomb filter having excellent erosion resistance at the sealing portions and also excellent thermal shock resistance, there is still room for improvement in terms of catalyst coating property. Patent Literature 2 describes a honeycomb filter that has excellent collection performance and is capable of reducing pressure loss by controlling the porosity, average pore size, pore size distribution, and thickness of the partition walls within predetermined ranges. However, there is still room for improvement in terms of catalyst coating property.

The present invention has been made in consideration of the above circumstances, and an object in one embodiment is to provide a honeycomb structure which satisfies all of the following requirements: excellent PM collection performance, low pressure loss, excellent catalyst coating property when a catalyst is carried, difficulty to be clogged by ash, and excellent mechanical strength.

The present inventors have conducted extensive research to solve the above problems and have completed the present invention, which is exemplified as below.

### [Aspect 1]

A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface, wherein the plurality of outlet cells is adjacent to at least one of the plurality of inlet cells with a partition wall interposed therebetween;
wherein a ratio of an opening area (Cᵢₙ) of each of the plurality of inlet cells to an opening area (Cₒᵤₜ) of each of the plurality of outlet cells satisfies 1<Cᵢₙ/Cₒᵤₜ≤2.5,
wherein a thickness (WT) of the partition wall is 0.18 to 0.25 mm,
wherein a cell density (CD) based on a total number of the plurality of inlet cells and the plurality of outlet cells is 49 to 70 cells/cm²,
wherein a depth (PD) of the sealing portion is 4 to 7 mm,
wherein in a cross section of the honeycomb structure perpendicular to a direction in which the plurality of inlet cells and the plurality of outlet cells extend, a distance (OF) between a midpoint of a line segment connecting centers of gravity of the inlet cell and the outlet cell adjacent to each other with the partition wall interposed therebetween and a center of the partition wall intersected by the line segment is 0.075 to 0.110 mm, and
wherein 2≤OF×CD/(WT×PD)≤7 is satisfied;

### [Aspect 2]

The honeycomb structure according to Aspect 1, wherein the partition wall has a porosity of 52 to 61%.

### [Aspect 3]

The honeycomb structure according to Aspect 1 or 2, wherein the partition wall has an average pore size of 6 to 10 μm.

### [Aspect 4]

The honeycomb structure according to any one of Aspects 1 to 3, wherein opening shapes of the plurality of inlet cells are all hexagonal or octagonal except for those adjacent to the outer peripheral side wall.

### [Aspect 5]

The honeycomb structure according to any one of Aspects 1 to 4, wherein the partition wall comprises one or more selected from cordierite, silicon carbide, silicon-silicon carbide composite material, silicon nitride, mullite, alumina, and aluminum titanate.

### [Aspect 6]

The honeycomb structure according to any one of Aspects 1 to 5, wherein a catalyst is carried on the partition wall.

The honeycomb structure according to one embodiment of the present invention satisfies all of the following requirements: excellent PM collection performance, low pressure loss, excellent catalyst coating property when a catalyst is carried, difficulty to be clogged by ash, and excellent mechanical strength. Therefore, according to one embodiment of the present invention, it can be said that it is possible to provide a honeycomb structure which is extremely excellent in practical use and can be suitably used as a filter for exhaust gas discharged from an internal combustion engine such as a diesel engine.

### BRIEF DESCRIPTION OF THE DRAWINGS

FIG. 1 is a perspective view showing a wall-flow type honeycomb structure.

FIG. 2 is a schematic cross-sectional view of a wall-flow type honeycomb structure observed from a cross section parallel to the direction in which the cells extend.

FIG. 3 is a schematic partial enlarged view of a partition wall of a honeycomb structure observed from a cross section orthogonal to the direction in which the cells extend.

FIG. 4 is an explanatory diagram showing a schematic example of a method for forming sealing portions using a squeegee method.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

(1. Honeycomb Structure)

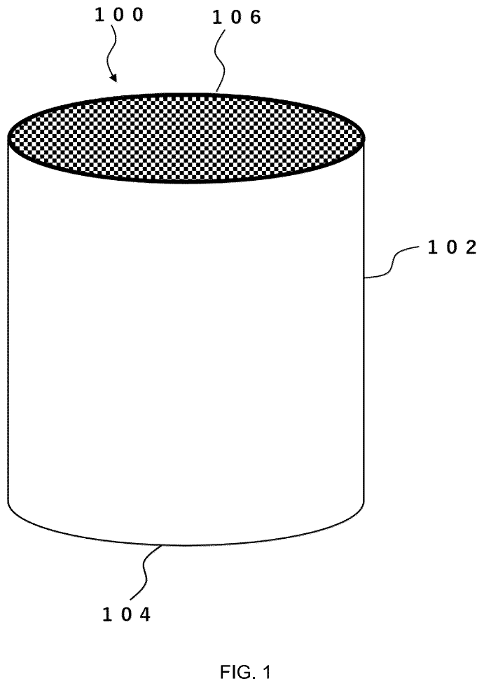

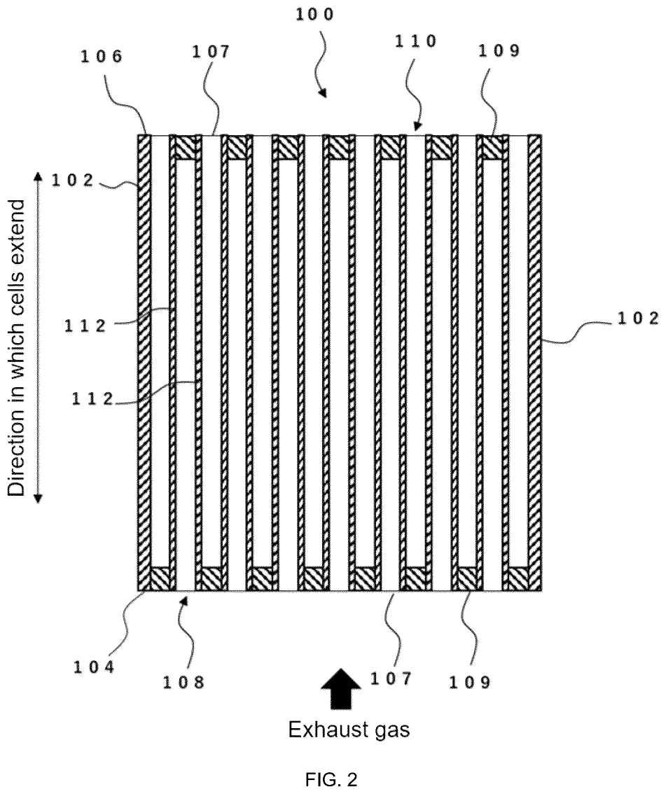

FIGS. 1 and 2 are a schematic perspective view and a cross-sectional view, respectively, of a pillar-shaped honeycomb structure 100 that can be used as a wall-flow type exhaust gas filter for automobiles. The honeycomb structure 100 comprises: an outer peripheral side wall 102; a plurality of inlet cells 108 arranged on the inner peripheral side of the outer peripheral side wall 102, extending from an inlet end surface 104 to an outlet end surface 106 in parallel, having an opening 107 at the inlet end surface 104, and having a sealing portion 109 at the outlet end surface 106; and a plurality of outlet cells 110 arranged on the inner peripheral side of the outer peripheral side wall 102, extending from the inlet end surface 104 to the outlet end surface 106 in parallel, having a sealing portion 109 at the inlet end surface, and having an opening 107 at the outlet end surface 106, wherein the plurality of outlet cells 110 is adjacent to at least one of the plurality of inlet cells with a partition wall 112 interposed therebetween.

For example, when exhaust gas containing particulate matter such as soot is supplied to the upstream inlet end surface 104 of the honeycomb structure 100, the exhaust gas is introduced into the inlet cells 108 and travels downstream within the inlet cells 108. Since the inlet cells 108 are sealed at the outlet end surface 106 on the downstream side, the exhaust gas passes through the partition wall located between the adjacent inlet cell 108 and outlet cell 110 and flows into the outlet cell 110. Since the particulate matter cannot pass through the partition wall, it is collected and deposited in the inlet cells 108. After the particulate matter has been removed, the clean exhaust gas that has flowed into the outlet cell 110 advances downstream within the outlet cells 110 and flows out from the outlet end surface 106 on the downstream side.

The honeycomb structure 100 satisfies the following predetermined conditions (1) to (6), which makes it possible to satisfy all of the following requirements: excellent PM collection performance, low pressure loss, excellent catalyst coating property when carrying a catalyst, difficulty to be clogged by ash, and excellent mechanical strength.
(1) A ratio of the opening area (Cᵢₙ) of each of the plurality of inlet cells 108 to the opening area (Cₒᵤₜ) of each of the plurality of outlet cells 110 (Cᵢₙ/Cₒᵤₜ)
(2) A thickness (WT) of the partition wall 112 (unit: mm)
(3) A cell density (CD) based on the total number of the plurality of inlet cells 108 and the plurality of outlet cells 110 (unit: cells/cm²)
(4) A depth (PD) of the sealing portion 109 (unit: mm)
(5) In a cross section of the honeycomb structure 100 perpendicular to the direction in which the plurality of inlet cells 108 and the plurality of outlet cells 110 extend, a distance (OF) between the midpoint of a line segment connecting the centers of gravity of the inlet cell 108 and the outlet cell 110 adjacent to each other with the partition wall 112 interposed therebetween and the center of the partition wall 112 intersected by the line segment (hereinafter also referred to as “offset”) (unit: mm)
(6) OF×CD/(WT×PD)
   (1) Cᵢₙ/Cₒᵤₜ

The ratio (Cᵢₙ/Cₒᵤₜ) of the opening area (Cᵢₙ) of each of the plurality of inlet cells 108 to the opening area (Cₒᵤₜ) of each of the plurality of outlet cells 110 preferably satisfies 1<Cᵢₙ/Cₒᵤₜ≤2.5, more preferably satisfies 1.5<Cᵢₙ/Cₒᵤₜ≤2.5, and even more preferably satisfies 1.5<Cᵢₙ/Cₒᵤₜ≤2.2.

The opening area (Cᵢₙ) of each of the plurality of inlet cells 108 is defined as the average opening area of all the inlet cells excluding the cells adjacent to the outer peripheral side wall 102.

The opening area (Cₒᵤₜ) of each of the plurality of outlet cells 110 is defined as the average opening area of all the outlet cells excluding the cells adjacent to the outer peripheral side wall 102.

The opening area (Cᵢₙ) of each of the plurality of inlet cells 108 is, for example, preferably 0.70 to 1.10 mm², more preferably 0.70 to 1.00 mm², and even more preferably 0.75 to 0.90 mm².

### (2) WT

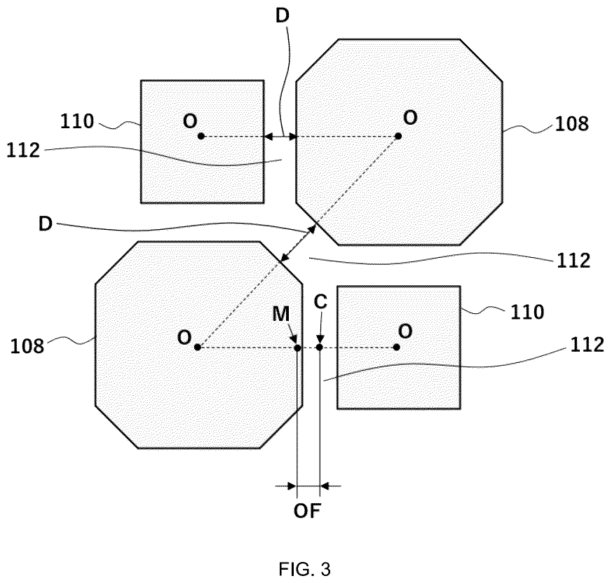

The thickness (WT) of the partition wall 112 is preferably 0.18 to 0.25 mm, more preferably 0.18 to 0.24 mm, and even more preferably 0.18 to 0.23 mm. Here, the thickness (WT) of the partition wall 112 means the average value of the thicknesses (WT) of all the partition walls 112. FIG. 3 shows a schematic enlarged partial view of the partition walls 112 of the honeycomb structure 100 in which the opening shape of the inlet cells 108 is octagonal and the opening shape of the outlet cells 110 is quadrangle, observed at a cross section orthogonal to the direction in which cells extend. The thickness (WT) of the partition wall 112 refers to a crossing length D of a line segment that crosses the partition wall when the centers of gravity O of adjacent cells are connected by this line segment in a cross-section orthogonal to the direction in which the cells extend (the height direction of the honeycomb structure 100).

In addition, “two cells are adjacent to each other with a partition wall interposed therebetween” means that when the partition wall of the honeycomb structure is observed from the cross section orthogonal to the direction in which the cells extend, the two cells are adjacent to each other with opposing wall surfaces of a single partition wall (sides of the polygon that defines the cells) between them, but does not include cases where the two cells are adjacent to each other with vertices of the polygons that define the two cells interposed therebetween.

### (3) CD

The cell density (CD) based on the total number of the plurality of inlet cells 108 and the plurality of outlet cells 110 is preferably 49 to 70 cells/cm², more preferably 49 to 68 cells/cm², and even more preferably 50 to 66 cells/cm². Here, the cell density is calculated by dividing the total number of cells (including the sealed cells, the outlet cells 110 adjacent to the outer peripheral side wall 102, and the inlet cells 108 adjacent to the outer peripheral side wall 102) by the area of one end surface of the honeycomb structure excluding the outer peripheral side wall.

### (4) PD

The depth (PD) of the sealing portion 109 is preferably 4 to 7 mm, more preferably 4 to 6.5 mm, and even more preferably 5 to 6.5 mm. Here, the depth (PD) of the sealing portion 109 means the average value of the depths (PD) of all the sealing portions 109. The depth (PD) of each sealing portion 109 is measured by cutting the honeycomb structure along a cross section parallel to the height direction (the direction in which the cells extend) and cutting out a cross section of the sealing portion. In the cross section, the length in the direction in which the cells extend is measured from the position of the inlet end surface or outlet end surface where the sealing portion is formed to the deepest position where the sealing portion exists, which is regarded as the depth of the sealing portion 109.

### (5) OF (Offset)

Referring to FIG. 3, in the cross section perpendicular to the direction in which the plurality of inlet cells 108 and the plurality of outlet cells 110 of the honeycomb structure 100 extend, the distance between the midpoint M of a line segment connecting the centers of gravity O of the adjacent inlet cell 108 and outlet cell 110 separated by the partition wall 112 and the center C of the partition wall 112 intersected by the line segment is called OF (offset). The OF is preferably 0.075 to 0.110 mm, more preferably 0.075 to 0.105 mm, and even more preferably 0.080 to 0.105 mm. Here, OF means the average value of all the OFs that can be calculated.

### (6) OF×CD/(WT×PD)

It is desirable that the thickness (WT) of the partition wall 112, the cell density (CD), the depth (PD) of the sealing portion 109, and OF (offset) each satisfy the above-mentioned conditions individually, and in addition, OF×CD/(WT×PD) satisfies a predetermined condition. Specifically, it is preferable that 2≤OF×CD/(WT×PD)≤7 be satisfied, more preferable that 2.2≤OF×CD/(WT×PD)≤6.9 be satisfied, even more preferable that 2.4≤OF×CD/(WT×PD)≤6.9 be satisfied, even more preferable that 3.0≤OF×CD/(WT×PD)≤6.9 be satisfied, even more preferable that 4.0≤OF×CD/(WT×PD)≤6.5 be satisfied, and even more preferable that 5.0≤OF×CD/(WT×PD)≤6.0 be satisfied.

From the viewpoint of further reducing the pressure loss, the lower limit of the porosity of the partition wall 112 is preferably 52% or more, and more preferably 53% or more. In addition, from the viewpoint of further increasing the mechanical strength of the honeycomb structure, the upper limit of the porosity of the partition wall 112 is preferably 61% or less, and more preferably 60% or less. Therefore, the partition wall preferably has a porosity of, for example, 52 to 61%, and more preferably 53 to 60%. As used herein, the porosity is measured by the mercury porosimetry in accordance with JIS R1655: 2003. In addition, the porosity is determined by taking partition wall samples (0.3 g each) from six locations of the honeycomb structure without bias, and measuring the porosity of each sample, and the average value is regarded as the measured value.

From the viewpoint of further improving the particulate matter collection efficiency, the average pore size of the partition wall 112 is preferably 10 μm or less, and more preferably 9 μm or less. In addition, from the viewpoint of further reducing the pressure loss, the average pore size of the partition wall 112 is preferably 6 μm or more, and more preferably 7 μm or more. Therefore, the average pore size of the partition wall 112 is preferably, for example, 6 to 10 μm, and more preferably 7 to 9 μm. The average pore size of the partition wall is measured by the mercury porosimetry in accordance with JIS R1655: 2003. Twenty test pieces of the partition walls are uniformly taken from the central portion and the outer peripheral portion of the pillar-shaped honeycomb structure, and the average pore size of each is measured. The average value is regarded as the average pore size of the entire pillar-shaped honeycomb structure.

The shape of the opening of the inlet cell 108 is not particularly limited. For example, in the cross section orthogonal to the direction in which the cells of the honeycomb structure 100 extend, the shape can be a polygon (a quadrangle (rectangle, square), pentagon, hexagon, heptagon, octagon, and the like), a round shape (a circle, an ellipse, an oval, an egg shape, an elongated circular shape, and the like), and the like. These shapes may be adopted alone or in combination of two or more. Among these, for the reason of reducing pressure loss, the opening shape of each of the plurality of inlet cells 108, except for those adjacent to the outer peripheral side wall 102, is preferably all hexagonal or octagonal, and more preferably octagonal. When the opening shape of the inlet cell 108 and the outlet cell 110 is polygonal, the corners may be rounded. As used herein, even if the corners are rounded, they are treated as polygonal.

The opening shape of the outlet cell 110 is not particularly limited, and may be set to match the opening shape of the inlet cell 108. For example, when the opening shape of the inlet cell 108 is octagonal, it is preferable to adopt a quadrangle as the opening shape of the outlet cell 110.

The shape of the end surface of the honeycomb structure 100 is not limited either, and may be, for example, a round shape such as a circle, an ellipse, a racetrack shape, or a long circle shape, a polygonal shape such as a triangle or a quadrangle, or other irregular shape. The illustrated honeycomb structure 100 has a circular shape at the end surface and is cylindrical as a whole.

There is no particular limitation on the height of the honeycomb structure (the length from the inlet end surface to the outlet end surface), and it may be appropriately set depending on the application and required performance. The height of the honeycomb structure may be, for example, 40 to 450 mm, preferably 60 to 400 mm, and more preferably 100 to 330 mm. There is no particular limitation on the relationship between the height of the honeycomb structure and the maximum diameter of each end surface (the maximum length of the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

From the viewpoint of obtaining excellent thermal shock resistance, at least the partition walls of the honeycomb structure, preferably the outer peripheral side wall and the partition walls, and more preferably the outer peripheral side wall, the partition walls and the sealing portions comprise one or more selected from cordierite, silicon carbide, a silicon-silicon carbide composite material, silicon nitride, mullite, alumina and aluminum titanate.

The outer peripheral side wall, the partition walls and the sealing portions of the honeycomb structure may comprise ceramics other than those mentioned above. Other ceramics include, for example, zirconium phosphate, cordierite-silicon carbide composite, zirconia, spinel, indialite, sapphirine, corundum, titania, and ceria. Furthermore, as such other ceramics, one type may be contained alone, or two or more types may be contained in combination.

The honeycomb structure can also be used as a catalyst carrier. A catalyst can be carried on the surface of the partition walls according to the purpose. As to the catalyst, although not limited, mention can be made to a diesel oxidation catalyst (DOC) for oxidizing and burning hydrocarbons (HC) and carbon monoxide (CO) to increase exhaust gas temperature, a PM combustion catalyst that assists in the combustion of PM such as soot, an SCR catalyst and an NSR catalyst that remove nitrogen oxides (NOx), as well as a three-way catalyst that can simultaneously remove hydrocarbons (HC), carbon monoxide (CO), and nitrogen oxides (NOx). The catalyst may contain as appropriate, for example, noble metals (Pt, Pd, Rh, and the like), alkali metals (Li, Na, K, Cs, and the like), alkaline earth metals (Mg, Ca, Ba, Sr, and the like), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

The honeycomb structure may be a honeycomb joined body having a plurality of honeycomb segments and a joining layer joining the outer peripheral surfaces of the plurality of honeycomb segments together. By using a honeycomb joined body, it is possible to increase the total cross-sectional area of the cells, which is important for ensuring the flow rate of air, while suppressing the occurrence of cracks. The joining layer can be formed by using a joining material. The joining material is not particularly limited, and may be a ceramic material with a solvent such as water added thereto to form a paste. The joining material may contain the same material as the partition wall. In addition to the role of joining the honeycomb segments together, the joining material may also be used as an outer periphery coating material after joining the honeycomb segments.

### (2. Manufacturing Method)

A method for manufacturing a pillar-shaped honeycomb structure according to one embodiment of the present invention will be described below by way of example. First, a raw material composition containing a cordierite-forming raw material, a pore-forming material, a dispersion medium, and a binder is kneaded to form a green body, and then the green body is extrusion molded to obtain a pillar-shaped honeycomb formed body having an outer peripheral side wall, and a plurality of cells on the inner peripheral side of the outer peripheral side wall, extending from the inlet end surface to the outlet end surface, in which both the inlet end surface and the outlet end surface have openings. The raw material composition may contain additives such as a dispersant or other ceramic raw materials, as necessary. In extrusion molding, a die having a desired overall shape, cell shape, cell arrangement, partition wall thickness, cell density, and the like can be used.

The cordierite-forming raw material is a raw material that becomes cordierite when fired, and can be provided, for example, in the form of a powder. It is desirable that the cordierite-forming raw material have a chemical composition of alumina (Al₂O₃) (including aluminum hydroxide that converts to alumina): 30 to 45% by mass, magnesia (MgO): 11 to 17% by mass, and silica (SiO₂): 42 to 57% by mass.

The dispersion medium may be water or a mixed solvent of water and an organic solvent such as alcohol, and water is particularly preferred.

The content of the dispersion medium in the honeycomb formed body before a drying process is carried out is preferably 20 to 110 parts by mass, more preferably 25 to 100 parts by mass, and even more preferably 30 to 90 parts by mass, with respect to 100 parts by mass of the cordierite-forming raw material. When the content of the dispersion medium in the honeycomb formed body is 20 parts by mass or more with respect to 100 parts by mass of the cordierite-forming raw material, the quality of the honeycomb structure is likely to be stable. When the content of the dispersion medium in the honeycomb formed body is 110 parts by mass or less with respect to 100 parts by mass of the cordierite-forming raw material, the amount of shrinkage during drying is small, and deformation can be suppressed. As used herein, the content of the dispersion medium in the honeycomb formed body refers to a value measured by a loss on drying method.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, phenol, and the like. As the pore-forming material, one type may be used alone, or two or more types may be used in combination. From the viewpoint of increasing the porosity of the honeycomb structure after firing, the content of the pore-forming material is preferably 1 part by mass or more, more preferably 6 parts by mass or more, and even more preferably 9 parts by mass or more, with respect to 100 parts by mass of the cordierite-forming raw material. From the viewpoint of ensuring the strength of the honeycomb structure after firing, the content of the pore-forming material is preferably 30 parts by mass or less, more preferably 27 parts by mass or less, and even more preferably 24 parts by mass or less, with respect to 100 parts by mass of the cordierite-forming raw material.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. Further, from the viewpoint of increasing the strength of the honeycomb formed body before firing, the content of the binder is preferably 4 parts by mass or more, more preferably 4.5 parts by mass or more, and even more preferably 5 parts by mass or more, with respect to 100 parts by mass of the cordierite-forming raw material. From the viewpoint of suppressing the occurrence of cracks due to abnormal heat generation in the firing step, the content of the binder is preferably 9 parts by mass or less, more preferably 8 parts by mass or less, and even more preferably 7 parts by mass or less, with respect to 100 parts by mass of the cordierite-forming raw material. As the binder, one type may be used alone, and two or more types may be used in combination.

As the dispersant, ethylene glycol, dextrin, fatty acid soap, polyether polyol, and the like can be used. As the dispersant, one type may be used alone, and two or more types may be used in combination. The content of the dispersant is preferably 0 to 2 parts by mass with respect to 100 parts by mass of the cordierite-forming raw material.

For drying of honeycomb formed body, conventionally known drying methods such as hot gas drying, microwave drying, dielectric drying, reduced pressure drying, vacuum drying, and freeze drying can be used. Among these, a drying method that combines hot gas drying with microwave drying or dielectric drying is preferable since the entire honeycomb formed body can be dried quickly and uniformly.

After drying the honeycomb formed body, sealing portions are formed on both end surfaces of the honeycomb formed body. Each sealing portion can be formed by filling the openings of the inlet cells and outlet cells where the sealing portions are to be formed with a sealing portion forming slurry, and then drying and firing the filled slurry. The sealing portion forming slurry can be made of the material of the honeycomb formed body. For example, without being limited thereto, when the honeycomb formed body contains a cordierite-forming raw material, a pore forming material, a dispersion medium, and a binder, the sealing portion forming slurry can contain the cordierite-forming raw material, the pore forming material, the dispersion medium, and a binder.

For example, the sealing portion forming slurry contains 30 to 60 parts by mass of a dispersion medium, 5 to 20 parts by mass of a pore-forming material, and 0.2 to 2.0 parts by mass of a binder, with respect to 100 parts by mass of the cordierite-forming raw material. In a preferred embodiment, the sealing portion forming slurry contains 35 to 50 parts by mass of a dispersion medium, 8 to 16 parts by mass of a pore-forming material, and 0.2 to 1.5 parts by mass of a binder, with respect to 100 parts by mass of the cordierite-forming raw material.

The dispersion medium may be water or a mixed solvent of water and an organic solvent such as alcohol, and water is particularly preferred.

The pore-forming material is not particularly limited as long as it becomes pores after firing, and examples thereof include wheat flour, starch, foamed resin, water-absorbent resin, silica gel, carbon (for example, graphite), ceramic balloons, polyethylene, polystyrene, polypropylene, nylon, polyester, acrylic resin, phenol, and the like. As the pore-forming material, one type may be used alone, or two or more types may be used in combination.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. As the binder, one type may be used alone, and two or more types may be used in combination.

The sealing portion forming slurry may contain a dispersant as appropriate. Examples of the dispersant include ethylene glycol, dextrin, fatty acid soap, polyalcohol, and the like. As the dispersant, one type may be used alone, or two or more types may be used in combination.

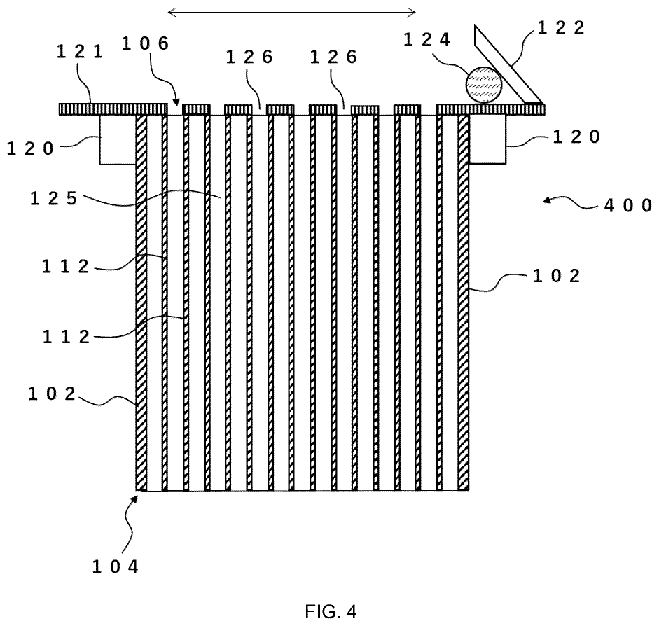

The openings of the cells can be filled with the sealing portion forming slurry by, for example, the following “squeegee method.” As shown in FIG. 4, a film 121 is attached to the upper end surface (here, the outlet end surface 106 in the figure) of the dried honeycomb formed body 400 fixed by a chuck 120, and a laser is irradiated onto the film 121 at positions corresponding to the arrangement conditions of the sealing portions, thereby drilling a plurality of holes 126 in the film 121.

Thereafter, a sealing portion forming slurry 124 is placed on the film 121, and a squeegee 122 is moved along the film 121 in the direction of the arrow in FIG. 4. As a result, a certain amount of sealing portion forming slurry 124 is filled into cells 125 that are open at positions corresponding to the holes 126 of the film 121.

The depth of the sealing portion can be changed by the number of times the squeegee 122 is moved, the contact angle between the squeegee 122 and the film 121, the pressing pressure of the squeegee 122 against the film 121, and the viscosity of the sealing portion forming slurry 124, and the like.

After filling the sealing portion forming slurry 124, the film 121 is peeled off, and the entire honeycomb formed body 400 is dried. As a result, the sealing portion forming slurry 124 filled in the cells 125 is dried, and the sealing portions before firing are formed. Drying can be performed, for example, under conditions of a drying temperature of 100 to 230° C. for about 60 to 150 seconds. After drying, the sealing portions protrude from the end surfaces of the honeycomb formed body by the thickness of the film, and can be scraped off as necessary.

The material of the film is not particularly limited, but is preferably polypropylene (PP), polyethylene terephthalate (PET), polyimide, or Teflon (registered trademark), since these materials are easily heat-processed to form holes. The film preferably has an adhesive layer, and the material of the adhesive layer is preferably an acrylic resin, a rubber-based material (for example, a rubber whose main component is natural rubber or synthetic rubber), or a silicone-based resin. The film may be, for example, an adhesive film having a thickness of 20 to 50 μm.

Besides the above-mentioned “squeegee method”, another method for filling the openings of the cells with the sealing portion forming slurry is the “pressure-in method.” The “press-in method” is a method in which an end surface of a honeycomb formed body with a film attached and holes drilled therein is immersed in a liquid tank containing a sealing portion forming slurry, and the cells are filled with the sealing portion forming slurry. In this case, the depth of the sealing portions can be changed by changing the depth to which the honeycomb formed body is immersed in the sealing portion forming slurry.

The honeycomb formed body filled with the sealing portion forming slurry is then subjected to a degreasing step and a firing step, thereby manufacturing a honeycomb structure. The combustion temperature of the binder is about 200° C., and the combustion temperature of the pore-forming material is about 300 to 1000° C. Therefore, the degreasing step may be carried out by heating the honeycomb formed body to a range of about 200 to 1000° C. The heating time is not particularly limited, but is usually about 10 to 100 hours. The honeycomb molded body after the degreasing process is called a calcined body. The firing process depends on the material composition of the honeycomb structure, but can be carried out, for example, by heating the calcined body to 1300 to 1450° C. and holding it for 3 to 24 hours.

A catalyst can be carried on the partition walls of the honeycomb structure thus manufactured. One example of a method for carrying a catalyst on the partition walls includes introducing a catalyst slurry into the cells by a conventionally known suction method or the like, for allowing it to adhere to the surfaces and pores of the partition walls, and then subjecting it to a high-temperature treatment is performed to bake the catalyst contained in the catalyst slurry onto the partition walls. The types of catalyst are as exemplified above.

### Examples

Hereinafter, the following examples are provided to better understand the present invention and its advantages, but the present invention is not limited to these examples.

### (1. Manufacturing of Honeycomb Structure)

### [Honeycomb Structure Made of Cordierite: Comparative Examples 1 to 7, Examples 1 to 5]

To 100 parts by mass of the cordierite-forming raw material, 2 parts by mass of a pore-forming material, 20 parts by mass of a dispersion medium, and 7 parts by mass of an organic binder were added, and they were mixed and kneaded to prepare a green body. The cordierite-forming raw material used was alumina, aluminum hydroxide, kaolin, talc, and silica. The dispersion medium used was water. The organic binder used was methyl cellulose. The pore-forming material used was a water-absorbent resin with a median diameter of 20 μm. In these Examples, the median diameter of the raw material refers to the particle size at an integrated value of 50% (D50) in the particle size distribution obtained by a laser diffraction/scattering method.

Next, the green body was extrusion molded using a die for preparing a honeycomb formed body, to obtain a honeycomb formed body having an overall shape of a cylindrical shape. The structure of the die was changed depending on the test numbers.

Next, the honeycomb formed body was dried in a microwave dryer and further dried in a hot gas dryer, after which both end surfaces of the honeycomb formed body were cut to a predetermined size.

Next, a slurry for forming sealing portion was prepared using the same material as the honeycomb formed body. After that, using this slurry, sealing portions were formed at the openings of the predetermined cells on the inlet end surface side and at the openings of the remaining cells on the outlet end surface side of the dried honeycomb formed body, such that the inlet cells and the outlet cells were alternately adjacent to each other.

Next, each of the honeycomb formed bodies with sealing portions formed therein was degreased and fired to manufacture a honeycomb structure according to each test number. The honeycomb structure thus obtained had a cylindrical shape with circular inlet and outlet end surfaces. The diameters of the inlet end surface and the outlet end surface were 330 mm. The length of the honeycomb structure in the direction in which the cells extend was 254 mm. A required number of the honeycomb structures to specify the following characteristics were prepared.

### (2. Structural Characteristics of Honeycomb Structure)

Table 1 shows the structural characteristics of the honeycomb structures manufactured as above according to each test number.
Thickness of the partition wall (WT).
Cell density (CD) based on the total number of the plurality of inlet cells and the plurality of outlet cells.
Ratio (Cᵢₙ/Cₒᵤₜ) of the opening area (Cᵢₙ) of each of the plurality of inlet cells to the opening area (Cₒᵤₜ) of each of the plurality of outlet cells
Offset (OF)
Depth (PD) of the sealing portion
OF×CD/(WT×PD)
Porosity of the partition wall
Average pore size of the partition wall
Opening shape of the inlet cells
Opening shape of the outlet cells

The thickness (WT) of the partition wall was measured by observation with a scanning electron microscope (SEM) or a microscope.

Cell density (CD) refers to the cell density based on the total number of inlet cells and outlet cells, and was measured according to the method described above.

Cᵢₙ/Cₒᵤₜ and Cᵢₙ were calculated by observation with a scanning electron microscope (SEM) or using a microscope.

The offset (OF) was measured by observation with a scanning electron microscope (SEM) or a microscope.

The depth of the sealing portion (PD) was measured by observation with a scanning electron microscope (SEM) or a microscope.

The porosity and average pore size of the partition walls were measured by the above-mentioned mercury intrusion method using an Autopore 9500 (product name) manufactured by Micromeritics Instrument Corporation.

The opening shapes of the inlet cells and the outlet cells were identified by observation with a scanning electron microscope (SEM) or a microscope.

TABLE 1

| | Partition | Cell | | | | Sealing | | | | Opening | Opening |
|---|---|---|---|---|---|---|---|---|---|---|---|
| | wall | density | | | Offset | portion | OF × CD/ | | Average | shape of | shape of |
| | thickness (WT) | (CD) | | Cᵢₙ | (OF) | depth (PD) | (WT | Porosity | pore size | inlet | outlet |
| Test No. | (mm) | (/cm²) | Cᵢₙ/Cₒᵤₜ | (mm²) | (mm) | (mm) | PD) | (%) | (μm) | cell | cell |
| Comparative | 0.28 | 47 | 1.00 | 0.71 | 0.000 | 8.0 | 0.0 | 52 | 11 | Quadrangle | Quadrangle |
| Example 1 | | | | | | | | | | | |
| Comparative | 0.25 | 31 | 1.47 | 1.43 | 0.075 | 9.0 | 1.0 | 50 | 13 | Octagon | Quadrangle |
| Example 2 | | | | | | | | | | | |
| Comparative | 0.17 | 78 | 2.06 | 0.65 | 0.090 | 5.0 | 8.4 | 53 | 12 | Octagon | Quadrangle |
| Example 3 | | | | | | | | | | | |
| Comparative | 0.18 | 36 | 1.45 | 1.33 | 0.070 | 3.0 | 4.7 | 58 | 5 | Octagon | Quadrangle |
| Example 4 | | | | | | | | | | | |
| Comparative | 0.15 | 56 | 1.00 | 0.70 | 0.000 | 7.0 | 0.0 | 63 | 9 | Quadrangle | Quadrangle |
| Example 5 | | | | | | | | | | | |
| Comparative | 0.33 | 49 | 1.55 | 0.75 | 0.060 | 7.5 | 1.2 | 51 | 8 | Octagon | Quadrangle |
| Example 6 | | | | | | | | | | | |
| Comparative | 0.25 | 39 | 1.60 | 1.14 | 0.080 | 8.0 | 1.5 | 55 | 8 | Octagon | Quadrangle |
| Example 7 | | | | | | | | | | | |
| Example 1 | 0.24 | 54 | 1.76 | 0.81 | 0.080 | 5.0 | 3.6 | 59 | 7 | Octagon | Quadrangle |
| Example 2 | 0.18 | 64 | 2.06 | 0.79 | 0.100 | 6.5 | 5.5 | 60 | 8 | Octagon | Quadrangle |
| Example 3 | 0.19 | 66 | 2.03 | 0.75 | 0.095 | 6.0 | 5.6 | 58 | 7 | Octagon | Quadrangle |
| Example 4 | 0.23 | 60 | 2.18 | 0.78 | 0.105 | 4.0 | 6.9 | 53 | 9 | Octagon | Quadrangle |
| Example 5 | 0.24 | 50 | 1.74 | 0.88 | 0.082 | 7.0 | 2.4 | 59 | 10 | Octagon | Quadrangle |

### 3. Filter Performance

The honeycomb structures having the respective test numbers prepared above were used as filters, and the following filter performance was evaluated.

### [Collection Performance]

First, the honeycomb filters of the respective Examples and Comparative Examples were canned in a metal case as filters for purifying exhaust gas, to prepare exhaust gas purification devices. Next, the prepared exhaust gas purification device was connected to the outlet side of an exhaust manifold of a 6.7 L diesel engine, and the number of soot particles contained in the gas discharged from the outlet of the exhaust gas purification device was measured by the PN measurement method. In determining the number of soot particles, the cumulative number of soot particles emitted after driving in the WHTC (World Harmonized Transient Cycle) mode was used as the number of soot particles in the exhaust gas purification device to be determined. The soot number ratio (%) of each honeycomb filter was calculated based on the number of soot particles in the exhaust gas purification device using the honeycomb filter of Comparative Example 1 being 100%, and each of the honeycomb filters of Examples and Comparative Examples was evaluated based on the following evaluation criteria. The results are shown in Table 2.
“Excellent” rating: the soot number ratio (%) is 80% or less.
“Good” rating: the soot number ratio (%) is more than 80% but 90% or less.
“Fair” rating: the soot number ratio (%) is more than 90% but 100% or less.
“Poor” rating: the soot number ratio (%) is more than 100%.

### [Pressure Loss]

Exhaust gas discharged from a 6.7 L diesel engine was made to flow into the filters of each of the Examples and Comparative Examples, and soot in the exhaust gas was collected within the filter. The soot collection was continued until the amount of soot deposited per unit volume (1 L) of the filter reached 5 g/L. Then, when the amount of soot deposition reached 5 g/L, engine exhaust gas at 200° C. was allowed to flow into the filter at a flow rate of 12 m³/min, and the pressure at the inlet end surface and outlet end surface of the filter were measured. Then, the pressure difference between the inlet end surface side and the outlet end surface side was calculated to determine the pressure loss (kPa) of the filter. The pressure loss of the filter of Comparative Example 1 was set as 100%, and the ratio (%) of the pressure loss of each of the filters of Examples and Comparative Examples was calculated, and the pressure loss of the filter was evaluated based on the following evaluation criteria. The results are shown in Table 2.
“Excellent” rating: the pressure loss ratio (%) is 70% or less.
“Good” rating: the pressure loss ratio (%) is more than 70% but 75% or less.
“Fair” rating: the pressure loss ratio (%) is more than 75% but 100% or less.
“Poor” rating: the pressure loss ratio (%) is more than 100%.

### [Catalyst Coating Property]

First, an oxidation catalyst was carried on the partition walls of the honeycomb filter in an amount of 10 g/L. Next, 3 g/L of soot was deposited in the honeycomb filter on which the catalyst was carried as described above. In this state, another honeycomb structure (catalyst carrier) carrying an oxidation catalyst was placed in front of the honeycomb filter. Then, high-temperature exhaust gas was made to flow from the upstream side of the front-stage honeycomb structure, and the exhaust gas that had passed through the front-stage honeycomb structure was flowed from the inlet end surface of the honeycomb filter, thereby performing continuous regeneration of the filter. The exhaust gas was discharged from a 6.7 L diesel engine. The regeneration conditions were a gas temperature at the inlet end surface of 350° C. and a gas flow time of 60 minutes. Thereafter, the honeycomb filter was removed from the device that had undergone continuous regeneration, and the amount of soot remaining in the honeycomb filter was measured. The percentage (%) of the ratio obtained by dividing the mass of soot reduced by the continuous regeneration by the mass of soot initially deposited was determined as the regeneration efficiency (%) during continuous regeneration. The regeneration efficiency of the filter in Comparative Example 1 was set as 100%, and the ratio (%) of the regeneration efficiency of each of the filters of Examples and Comparative Examples was calculated, and the catalytic performance of the filter was evaluated based on the following evaluation criteria. As catalyst coating property is higher, the catalyst can be coated more uniformly inside the filter, and therefore it is considered that the regeneration efficiency is higher. The results are shown in Table 2.
“Excellent” rating: the regeneration efficiency ratio (%) is over 115%.
“Good” rating: the regeneration efficiency ratio (%) is over 110% but 115% or less.
“Fair” rating: the regeneration efficiency ratio (%) is over 100% but 110% or less.
“Poor” rating: the regeneration efficiency ratio (%) is 100% or less.

### [Ash Clogging]

First, exhaust gas was introduced from the inlet end surface of the honeycomb filter using a 6.7 L diesel engine, and a predetermined amount of ash was deposited in the honeycomb filter. In addition, the amount of ash deposition was 30 g/L. The honeycomb filter after ash deposition was photographed by computed tomography (CT) to confirm the ash distribution inside the honeycomb filter. A sample was judged to be “pass” if no inlet cells were blocked midway by ash and ash accumulated on the outlet end surface side of the inlet cells, and a sample was judged to be “fail” if even one inlet cell was blocked midway by ash.

### [Strength]

The strength was measured based on the isostatic fracture strength test stipulated in M505-87 of the automobile standard (JASO standard) issued by the Society of Automotive Engineers of Japan. The isostatic fracture strength test is a test in which a honeycomb filter is placed in a cylindrical rubber container, covered with an aluminum plate, and subjected to isotropic compression in water. The isostatic strength measured by the isostatic fracture strength test is indicated by the pressurized pressure value (MPa) at which the honeycomb filter is fractured. When the isostatic strength is 1.0 MPa or more, it is considered to be “pass”, and when it is less than 1.0 MPa, it is considered to be “fail”.

TABLE 2

| | | | Catalyst | | |
|---|---|---|---|---|---|
| | Collection | Pressure | coating | Ash | |
| Test No. | performance | loss | property | clogging | Strength |
| Comparative | Reference | Reference | Reference | Fail | Pass |
| Example 1 | | | | | |
| Comparative | Poor | Fair | Poor | Pass | Pass |
| Example 2 | | | | | |
| Comparative | Poor | Excellent | Good | Fail | Pass |
| Example 3 | | | | | |
| Comparative | Excellent | Excellent | Fair | Pass | Fail |
| Example 4 | | | | | |
| Comparative | Fair | Excellent | Good | Fail | Fail |
| Example 5 | | | | | |
| Comparative | Excellent | Poor | Fair | Pass | Pass |
| Example 6 | | | | | |
| Comparative | Excellent | Fair | Poor | Pass | Pass |
| Example 7 | | | | | |
| Example 1 | Excellent | Good | Good | Pass | Pass |
| Example 2 | Good | Excellent | Excellent | Pass | Pass |
| Example 3 | Excellent | Excellent | Excellent | Pass | Pass |
| Example 4 | Good | Fair | Fair | Pass | Pass |
| Example 5 | Fair | Good | Fair | Pass | Pass |

### (4. Discussion)

From the results of the filter performance tests conducted on the honeycomb structures according to the Examples and Comparative Examples, it can be understood that in the Examples in which Cᵢₙ/Cₒᵤₜ, the partition wall thickness (WT), the cell density (CD), the sealing portion depth (PD), the offset (OF), and OF×CD/(WT×PD) were all appropriate, excellent PM collection performance, low pressure loss, excellent catalyst coating property when carrying a catalyst, difficulty to be clogged by ash, and excellent mechanical strength were all satisfied. Furthermore, it can be seen that Examples 2 and 3, in which OF×CD/(WT×PD) was optimal, were able to satisfy the required characteristics at a high level. On the other hand, in the Comparative Examples, since one or more of Cᵢₙ/Cₒᵤₜ, the partition wall thickness (WT), the cell density (CD), the sealing portion depth (PD), the offset (OF), and OF×CD/(WT×PD) were not appropriate, it is understood that all of excellent PM collection performance, low pressure loss, excellent catalyst coating property when carrying a catalyst, difficulty to be clogged by ash, and excellent mechanical strength could not be satisfied.

### DESCRIPTION OF REFERENCE NUMERALS

100: Honeycomb structure
102: Outer peripheral side wall
104: Inlet end surface
106: Outlet end surface
107: Opening
108: Inlet cell
109: Sealing portion
110: Outlet cell
112: Partition wall
120: Chuck
121: Film
122: Squeegee
124: Sealing portion forming slurry
125: Cell
126: Hole
400: Honeycomb formed body

1. A pillar-shaped honeycomb structure, comprising:
an outer peripheral side wall;
a plurality of inlet cells arranged on an inner peripheral side of the outer peripheral side wall, extending from an inlet end surface to an outlet end surface, having an opening at the inlet end surface, and having a sealing portion at the outlet end surface; and
a plurality of outlet cells arranged on the inner peripheral side of the outer peripheral side wall, extending from the inlet end surface to the outlet end surface, having a sealing portion at the inlet end surface, and having an opening at the outlet end surface, wherein the plurality of outlet cells is adjacent to at least one of the plurality of inlet cells with a partition wall interposed therebetween;
wherein a ratio of an opening area (Cᵢₙ) of each of the plurality of inlet cells to an opening area (Cₒᵤₜ) of each of the plurality of outlet cells satisfies 1<Cᵢₙ/Cₒᵤₜ≤2.5,
wherein a thickness (WT) of the partition wall is 0.18 to 0.25 mm,
wherein a cell density (CD) based on a total number of the plurality of inlet cells and the plurality of outlet cells is 49 to 70 cells/cm²,
wherein a depth (PD) of the sealing portion is 4 to 7 mm,
wherein in a cross section of the honeycomb structure perpendicular to a direction in which the plurality of inlet cells and the plurality of outlet cells extend, a distance (OF) between a midpoint of a line segment connecting centers of gravity of the inlet cell and the outlet cell adjacent to each other with the partition wall interposed therebetween and a center of the partition wall intersected by the line segment is 0.075 to 0.110 mm, and
wherein 2≤OF×CD/(WT×PD)≤7 is satisfied.

2. The honeycomb structure according to claim 1, wherein the partition wall has a porosity of 52 to 61%.

3. The honeycomb structure according to claim 1, wherein the partition wall has an average pore size of 6 to 10 μm.

4. The honeycomb structure according to claim 1, wherein opening shapes of the plurality of inlet cells are all hexagonal or octagonal except for those adjacent to the outer peripheral side wall.

5. The honeycomb structure according to claim 1, wherein the partition wall comprises one or more selected from cordierite, silicon carbide, silicon-silicon carbide composite material, silicon nitride, mullite, alumina, and aluminum titanate.

6. The honeycomb structure according to claim 1, wherein a catalyst is carried on the partition wall.
